(19) United States
(12) Patent Application Publication
(10) Pub. No.: US 2002/0178882 A1
(43) Pub. Date: Dec. 5, 2002

(54) Method and an apparatus for cutting sheet members

(76) Inventor: Hiroshi Shoda, Shizuoka-ken (JP)

Correspondence Address: HARNESS, DICKEY & PIERCE, P.L.C., P.O. BOX 828, BLOOMFIELD HILLS, MI, 48303, US

(21) Appl. No.: 10/160,830

(22) Filed: May 31, 2002

(30) Foreign Application Priority Data
May 31, 2001 (JP) 2001-164278

(51) Int. Cl. B26D 1/00; B26D 7/02

(52) U.S. Cl. 83/13; 83/452

(57) ABSTRACT

A method and an apparatus for cutting plate-shaped or sheet members to form parts that do not require a screwing operation and thus improve the operability in manufacturing parts of a desired configuration from the sheet member. The method for cutting sheet or plate-shaped members to form parts of a desired configuration from the sheet members includes cutting them by pressing them down from above. A first cutting step cuts a substantial portion of the outline of the desired configuration leaving a small portion of the outline uncut by weakly pressing the sheet members down from above around a portion to be cut. A second cutting step cuts the parts out from the sheet members of the desired configuration by cutting the small uncut portion by strongly pressing down around the desired configurations.

### CROSS-REFERENCE TO RELATED APPLICATIONS

This application claims the benefit of Japanese Patent Application No. 2001-164278, filed on May. 31, 2001.

### BACKGROUND OF THE INVENTION

1. Field of the Invention

The present invention relates to method and an apparatus for cutting sheet or plate-shaped members to form parts of a desired configuration.

2. Description of Background Art

It has been usually carried out that a plurality of sheet members for example of aluminum are laid in a stacked manner on a table of a cutting apparatus and then are cut into a desired configuration using an end mill movable in three dimensions above the table in order to simultaneously have a plurality of parts of a same configuration. That is, it is possible to simultaneously obtain a plurality of parts of the desired configuration through one operation by driving the end mill until it arrives at the bottom one of the stacked sheet members.

However, it has been often caused that the cut out part or parts would be fly apart immediately after the cutting operation by the end mill had been completed. This sometimes causes damages on the parts and thus exerts an adverse effect on the yield. In a conventional manner, all the sheet members are fastened by screws in order to prevent the parts from flying apart from the sheet members on completion of the cutting operation.

However, the conventional manner requiring previous screw fastening operation of the sheet members is cumbersome and the operability would be further made worse particularly in forming a plurality of parts from one sheet member since the screw fastening operation should be made on every parts.

### SUMMARY OF THE INVENTION

It is, therefore, an object of the present invention to provide method and an apparatus for cutting plate-shaped or sheet members to form parts therefrom which do not require any screw fastening operation and thus enable to obtain an improved operability in manufacturing parts of a desired configuration from the sheet member.

According to the present invention, a method of cutting sheet or plate-shaped members to form parts of a desired configuration from the sheet members by cutting them with pressing them down from above comprises: a first cutting step for cutting a substantial portion of the outline of the desired configuration leaving a small portion of the outline uncut with weakly pressing the sheet members down from above around a portion to be cut, and a second cutting step for cutting the parts out from the sheet members of the desired configuration by cutting the small portion left uncut with strongly pressing down therearound.

According to the present invention, since the sheet members are weakly pressed down from above in the first cutting step, it is possible to prevent cut chips from incoming between sheet members as well as since the parts of the desired configuration are strongly pressed down around the small portion left uncut in the second cutting step, it is possible to prevent the parts from being flied apart from the sheet members.

Also according to the invention, it is possible to eliminate the screw fastening operation of the sheet members in the prior art and thus to improve the operability in cutting parts out from the sheet members.

Further according to the present invention, an apparatus for cutting sheet members to form parts of a desired configuration from the sheet members by cutting them with pressing them down from above comprises: a table on which the sheet members are laid and positioned, cutting means movable in three dimensions for cutting the sheet members on the table into the desired configuration, and presser means for pressing the sheet members down around a portion to be cut, the sheet members are weakly pressed down by the presser means when a substantial portion of the outline of the desired configuration is cut by the cutting means with leaving a small portion of the outline uncut, and the sheet members are strongly pressed down around the small portion left uncut when it is cut by the cutting means to form parts of desired configuration.

Further, it is possible to eliminate the screw fastening operation of the sheet members in the prior art and thus to improve the operability in cutting parts out from the sheet members.

It is preferable, that the presser means is separably connected to driving portion of the cutting means, and that it is connected to the driving portion of the cutting means when the cutting means cuts the substantial portion of the outline of the desired configuration leaving the small portion of the outline uncut so as to be interlocked with the cutting means and is separated from the driving portion of the cutting means when the small portion left uncut is cut by the cutting means to form parts of the desired configuration so as to be made independent from the motion of the cutting means.

The presser means is interlocked with the driving portion of the cutting means and weakly presses the sheet members down and slides on the top surface of the sheet members together with the cutting means. It is possible to prevent the incoming of the cut chip between the sheet members during the cutting operation. Since the sheet members are strongly pressed down against the table, it is possible to prevent the flying of the finished parts apart from the sheet members.

It is preferable, that the table is movable in two directions orthogonally crossing with each other in a plane parallel to a floor surface, the presser means can be separably connected to the driving portion of the cutting means in one direction of said two directions and can be connected to the driving portion of the cutting means via extensible elastic members in the other direction of said two directions.

The presser means can be separably connected to the driving portion of the cutting means in one direction. The motion of the presser means in the other directions can be permitted by the extension and compression of the springs. Thus, it is possible to manufacture the cutting apparatus at low cost and to achieve easy maintenance.

It is also preferable that the elastic members are coil springs connecting between the presser means and the driving portion of the cutting means. The elastic members are formed by common coil springs. Also, it is possible to manufacture the cutting apparatus at low cost and to achieve easy maintenance.

### BRIEF DESCRIPTION OF THE DRAWINGS

Preferred embodiments of the present invention will be described with reference to the accompanied drawings in which;

FIG. 1 is a schematic view of the cutting apparatus according to one preferred embodiment of the present invention,

FIG. 2 is a plan view of the presser means of the cutting apparatus of FIG. 1,

FIG. 3 is a cross-sectional view taken along a line III-III of FIG. 2,

FIG. 4 is a schematic view of one sheet member and examples of outline of parts cut by the cutting apparatus,

FIG. 5 is a flow chart showing the cutting steps of the cutting apparatus of the present invention,

FIG. 6 is a plan view of the sheet member after completion of the first cutting step performed by the cutting apparatus of the present invention, and

FIG. 7 is a plan view of the presser means of the cutting apparatus according to another embodiment of the present invention.

### DESCRIPTION OF THE PREFERRED EMBODIMENTS

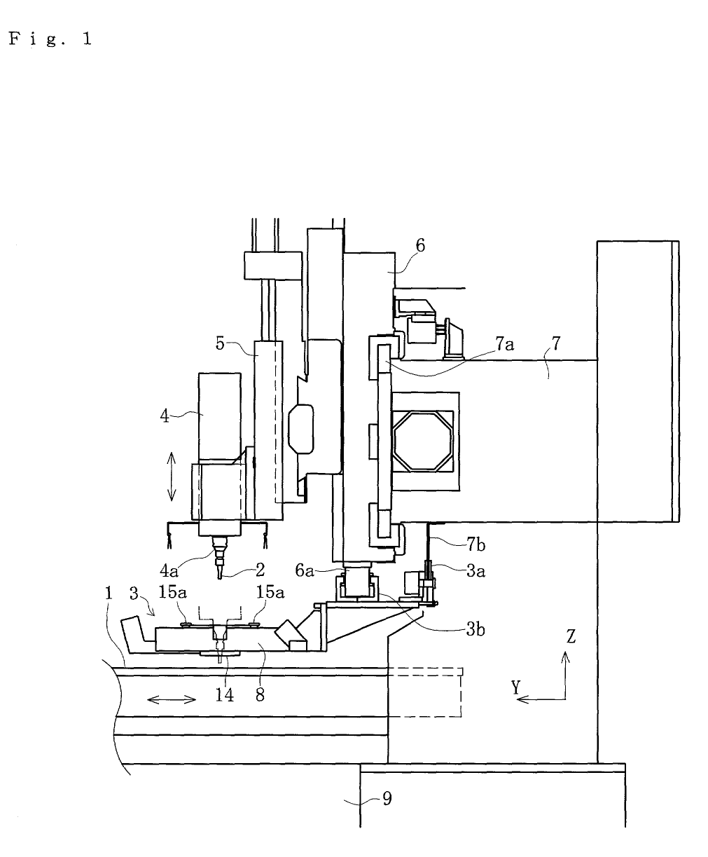

The cutting apparatus of the present invention is intended to form parts of the desired configuration by cutting them out from sheet members stacked on a table of the cutting apparatus with pressing the sheet members down from above against the table and generally comprises, as shown in FIG. 1, a table 1, an end mill 2 as a cutting means, and a presser means 3.

The table 1 on which the sheet members are laid and positioned is arranged on a bed 9 of the cutting apparatus and is provided with a plate of bakelite. A plurality of sheet member e.g. aluminum are laid on the table 1 in a stacked condition and secured thereon by a suitable clamping means such as a vice. The table 1 is reciprocally driven by a driving mechanism (not shown) arranged under the table 1 in left and right directions shown by an arrow “Y” in FIG. 1.

The end mill 2 is mounted via its shank on a holder 4a of a driving means 4 such as a motor and can be driven in three dimensions (“X” , “Y” and “Z” directions) above the table 1 to form parts of a desired configuration from the sheet members stacked on the table 1 by cutting the outline of the parts out from the sheet members. It is possible to use any other tool suitable for the outline cutting in place of the end mill 2.

Secured on the bed 9 is an annular column 7 on which two guiding rails 7a for slidably supporting a horizontal slider 6 are horizontally arranged. Thus the end mill 2 can be driven in three dimensions by the horizontal movement of the slider 6, the vertical movement of a vertical slider 5 and the reciprocal movement of the table 1.

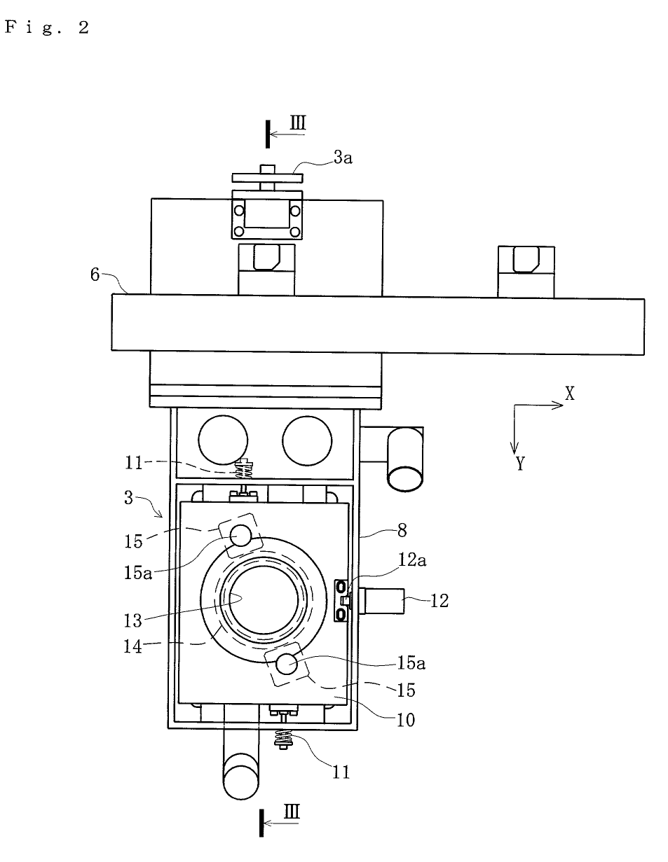

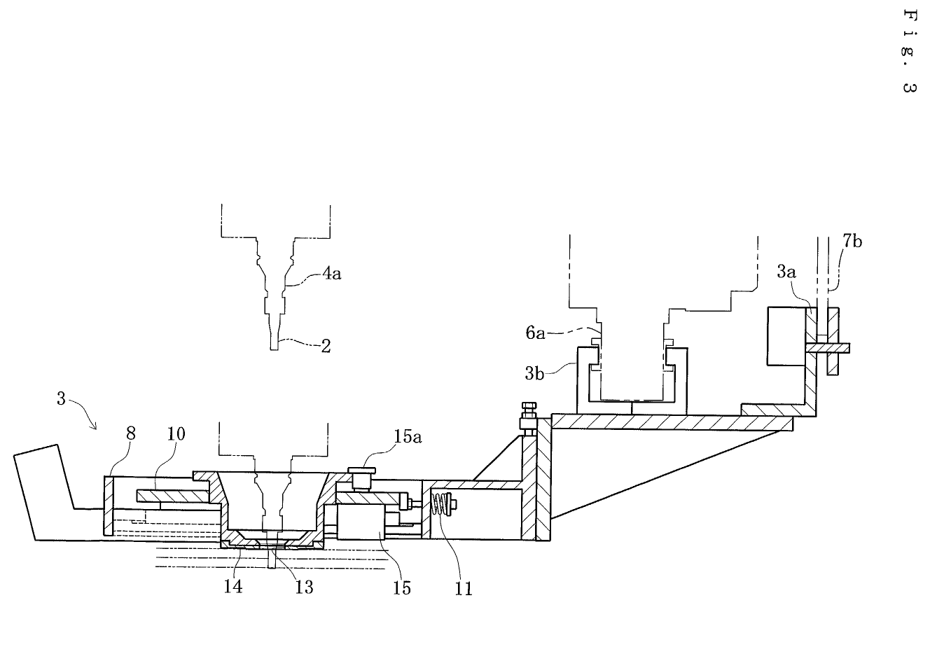

The presser means 3 is intended to press the sheet members down at a position around a place to be cut i.e. the end mill 2 and comprises, as shown in FIGS. 2 and 3, generally a main frame 8 and a sub frame 10 which are connected with each other via two coil springs 11 extending in the “Y” direction. One side of the main frame 8 is provided with a cylinder 12 having an extendable rod 12a to releasably lock the main frame 8 with the sub frame 10.

The base end of the main frame 8 is provided with first and second gripping means 3a and 3b actuated by hydraulic or pneumatic driving power. The first gripping means 3a is adapted to grip a stay 7b mounted on the annular column 7 and the second gripping means 3b is adapted to grip a stay 6a mounted on the horizontal slider 6. When the second gripping means 3b grips the stay 6a of the horizontal slider 6 acting as one of the driving portion of the end mill 2, the presser means 3 is connected to the horizontal slider 6 and thus is interlocked with the motion of the end mill 2 so that it can move in the direction “X”. Of course, under this situation it is necessary to keep the first gripping means 3a free from stay 7b and thus not to interfere the motion of the presser means 3 in the direction “X”.

On the contrary, when releasing the second gripping means 3b from the stay 6a and making the first gripping means 3a grip the stay 7b, the presser means 3 is freed from the end mill 2 in the direction “X” and is secured at the position. The connection and separation of the presser means 3 to and from the end mill 2 may be achieved by providing any projected members engageable with apertures formed in the slider 6 and the column 7.

The sub frame 10 is formed with a tool aperture 13 substantially at the center thereof through which the end mill 2 passes to cut the sheet members stacked on the table 1 along a predetermined outline. Mounted on the under surface of the presser means 3 around the periphery of the tool aperture 13 is a plastic pad 14 which is adapted to contact the top surface of the stacked sheet members on the table 1.

As previously described, since the sub frame 10 is connected to the main frame 8 via coil springs 11, it can be moved in the direction “Y” relative to the main frame 8 if it is not secured to the main frame 8 by the cylinder 12. Accordingly, the motion of the sub frame 10 in the direction “Y” is independent from the motion of the end mill 2, since the motion of the sub frame 10 in the direction “Y” is absorbed by expansion and compression of the coil springs 11 and thus is not transmitted to the main frame 8.

The sub frame 10 is provided with presser cylinders 15. The stacked sheet members are pressed down against the table 1 by the plastic pad 14 by extending piston rods 15a of the presser cylinders 15. The pressing force can be adjusted by controlling the amount of extension of the piston rods 15a.

The cutting operation will be hereinafter described.

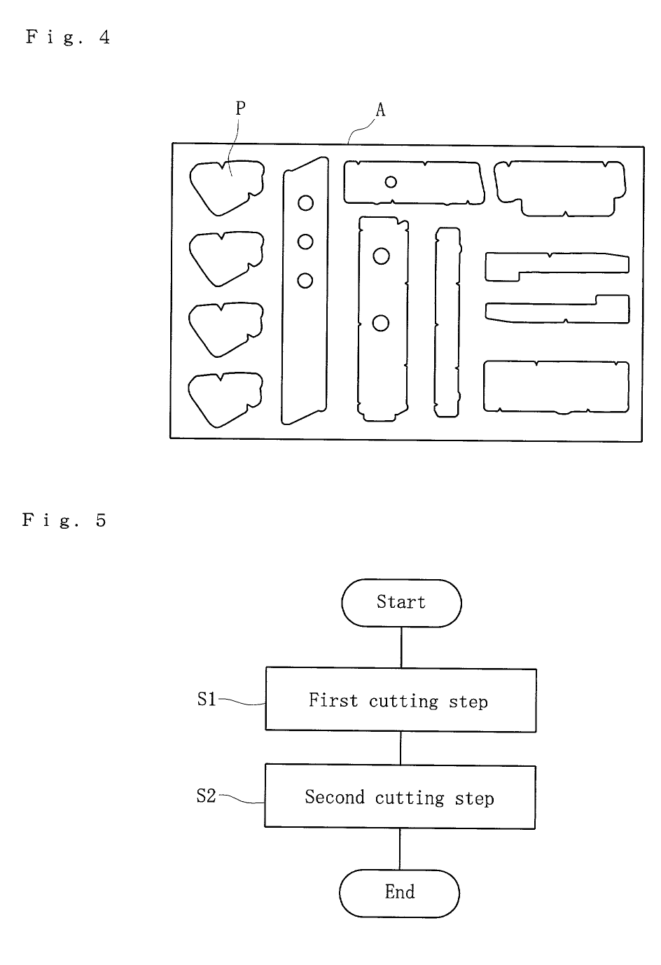

Firstly a predetermined number of the sheet members “A” such as aluminum sheets are laid on the table 1 in a stacked manner and secured to the table 1 by the vice. Several kinds of parts “P” each having a desired outline e.g. shown in FIG. 4 are cut out from the stacked sheet members “A” by moving the end mill 2 along the outline. The motion of the end mill 2 in the direction “X” is performed by the horizontal slider 6, the motion thereof in the direction “Y” is performed by moving the table 1 in the direction “Y” relative to the end mill 2, and the motion thereof in the direction “Z” is performed by the vertical slider 5.

The cutting operation is controlled in accordance with a manner shown in a flow chart of FIG. 5. In the first cutting step S1, the cutting along the desired outline is carried out by moving the end mill 2 along the outline with weakly pressing the stacked sheet members “A” down at a position around the cutting place i.e. around the end mill 2. In this first step S1, the first gripping means 3a is released from the stay 7b and the second gripping means 3b is connected to the stay 6a. Also in this first step S1, the main frame 8 and the sub frame 10 are united by causing the piston rod 12a of the cylinder 12 to be projected.

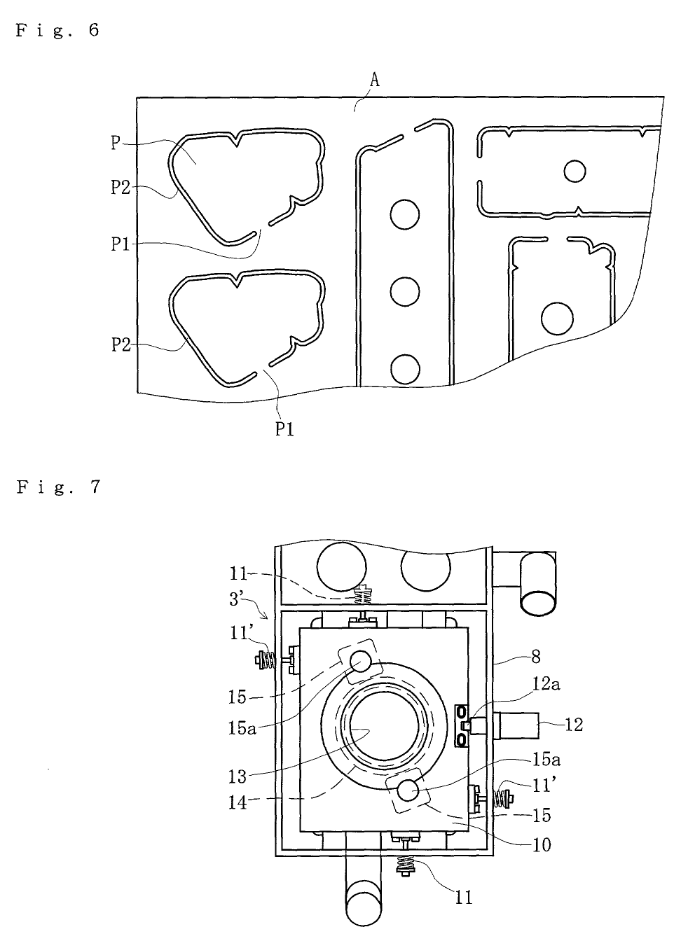

In the first cutting step S1, the cutting is carried out so that a portion of the desired outline is remained uncut as shown in FIG. 6. That is, the outline is cut along a portion P2 and remained uncut at a portion P1 to keep the parts “P” united with the sheet members “A”.

During the cutting operation in the first cutting step S1, since the presser means can slide on the top surface of the stacked sheet members and the portion P1 is kept uncut, it is possible to prevent the parts P1 from flying apart from the sheet members “A” as well as to prevent the cut chips from incoming between the sheet members. Several portions more than one may be kept uncut.

After the completion of the first cutting step SI and thus the cutting of the portion P2 of all the parts P, the second cutting step S2 starts. In this second cutting step S2, the uncut portion P1 is cut by the end mill 2 to form the final parts “P” of the desired configuration with strongly pressing the stacked sheet members “A” down around the uncut portion P1. In this second step S1, the first gripping means 3a is connected to the stay 7b and the second gripping means 3b is released from the stay 6a.

In this second cutting step S2, since the presser means 3 is freed from the motion of the end mill 2, it is not necessary to slide the presser means 3 on the top surface of the stacked sheet members. This enables the presser means 3 to strongly press the stacked sheet members “A” down against the table 1 and thus the cut parts “P” can be prevented from flying apart from the sheet members and from being damaged by impact. Since the end mill 2 operates within the aperture 13 also in the second cutting step S2, the presser means 3 should be positioned so that the uncut portion P1 is positioned within the aperture 13 of the presser means 3. Also in the second cutting step S2, the first gripping means 3a is arranged to grip the stay 7b and the second gripping means 3b is freed from the stay 6a as well as piston rod 12a of the cylinder 12 is retracted to release the sub frame 10 from the main frame 8.

In the second cutting step S2, the presser means 3 is separated from the horizontal slider 6 forming the driving portion of the end mill 2 and thus is independent from the end mill 2 in the direction “X”. On the other hand, when the sub frame 10 of the presser means 3 is moved in the direction “Y” together with the sheet members due to the strong pressing force acting on the sheet members, the motion of the sub frame 10 in the direction “Y” is absorbed by the compression and extension of the springs 11 and is not transmitted to the main frame 8. Thus, the motion of the presser means 3 is also independent from that of the end mill 2 in the direction

When cutting of all parts “P” is completed, the vice is released from clamping of the sheet member and thus the finished parts “P” can be removed from the sheet members “A”. Although it has been described to cut a plurality of sheet members, it should be noted that the cutting of the present invention can be carried out on one sheet member.

According to the present invention, since the sheet members are weakly pressed down in the first cutting step S1, it is possible to prevent the cut chips from incoming between the sheet members, and since the sheet members are strongly pressed down in the second cutting step S2, it is possible to prevent the cut parts “P” from flying apart from the sheet members. In addition, since the presser means 3 is separably connected to the driving portion of the end mill (i.e. the horizontal slider 6) via the second gripping means 3b, it is possible to interlock the presser means 3 with the end mill 2 in the first cutting step and to make the presser means 3 independent from the end mill 2 in the second cutting step S2.

Although the preferable embodiment of the present invention has been described above, the present invention is not limited to such an illustrated embodiment and it is possible to provide another cutting apparatus comprising a presser means 3′ having a following structure. That is, the presser means 3′ may have coil springs 11′ extending in the direction “X” in addition to the coil springs 11 extending in the direction “Y”. This enables to eliminate both the first and second gripping means 3a and 3b of the presser means 3.

In this embodiment, since the motion of the sub frame 10 in the direction “Y” is absorbed by the coil spring 11 and the motion thereof in the direction “X” is absorbed by the coil spring 11′, it is possible to simplify the mechanism for separating the presser means 3 from the end mill 2 in the second cutting step S2. The coil springs 11 and 11′ may be replaced by any other types of elastic members e.g. leaf springs etc.

Furthermore, the presser means 3 may be driven by any other driving means and the connection and separation of the motion of the presser means 3 to and from the end mill 2 may be carried out by that driving means. In this case, it is necessary to control the driving means so that the presser means 3 follows the motion of the end mill 2 in the first cutting step S1 and the presser means 3 is secured independent from the motion of the end mill 2 in the second cutting step S2. This structure using the driving means for the presser means 3 enables to achieve the reliable control of the motion of the presser means 3.

1. A method for cutting sheet or plate-shaped members to form parts of a desired configuration from the sheet members comprising:
a first cutting step cutting a substantial portion of an outline of the desired configuration;
leaving a small portion of the outline uncut by weakly pressing the sheet members down from above around a portion to be cut; and
a second cutting step cutting the parts out from the sheet members of the desired configuration by cutting the small uncut portion by strongly pressing down around the desired configuration.

2. An apparatus for cutting sheet members to form parts of a desired configuration from the sheet members comprising:
a table on which the sheet members are laid and positioned;
cutting member movable in three dimensions for cutting the sheet members on the table into the desired configuration; and
presser member for pressing the sheet members down around a portion to be cut, the sheet members being weakly pressed down by the presser member when a substantial portion of the outline of the desired configuration is cut by the cutting member leaving a small portion of the outline uncut, and the sheet members are strongly pressed down around the small uncut portion when it is cut by the cutting member to form parts of desired configuration.

3. An apparatus of claim 2 wherein the presser member is separably connected to a driving portion of the cutting member, and it is connected to the driving portion of the cutting member when the cutting member cuts the substantial portion of the outline of the desired configuration leaving the small portion of the outline uncut so as to be interlocked with the cutting member and is separated from the driving portion of the cutting member when the small uncut portion is cut by the cutting member to form parts of the desired configuration so as to be made independent from the motion of the cutting member.

4. An apparatus of claim 3 wherein the table is movable in two directions orthogonally crossing with each other in a plane parallel to a floor surface, the presser member can be separably connected to the driving portion of the cutting member in one direction of said two directions and can be connected to the driving portion of the cutting member via extensible elastic members in the other direction of said two directions.

5. An apparatus of claim 4 wherein the elastic members are coil springs connecting between the presser member and the driving portion of the cutting member.
